(19) United States
(12) Patent Application Publication
(10) Pub. No.: US 2005/0103584 A1
(43) Pub. Date: May 19, 2005

(54) Motorcycle disk-brake lock

(76) Inventor: Efraeyim Hogesta, Moshav Burgata (IL)

Correspondence Address: NATH & ASSOCIATES, 1030 15th STREET, NW, 6TH FLOOR, WASHINGTON, DC, 20005, US

(21) Appl. No.: 10/498,574

(22) PCT Filed: Dec. 5, 2002
(86) PCT No.: PCT/IL02/00986

Related U.S. Application Data
(60) Provisional application No. 60/339,464, filed on Dec. 14, 2001.

(51) Int. Cl. F16D 69/00

(52) U.S. Cl. 188/265

(57) ABSTRACT

A motorcycle disk-brake lock which makes it highly unlikely or prevents normal operation of the motorcycle while the lock is engaged with a disk-brake of the motorcycle and to thereby provide a clear alert to an operator thereof, and which can be conveniently stored and transported when not in use as a disk-brake lock.

### FIELD OF THE INVENTION

The present invention relates to a motorcycle disk-brake lock, and more particularly to a disk-brake lock which provides a clear indication to a user thereof that the lock is engaged with the disk-brake, to thereby prevent an offhand attempt to drive the motorcycle while the lock is engaged with the disk-brake.

### BACKGROUND OF THE INVENTION

Various anti-theft devices for motorcycles have been suggested along the years. The simplest security device is a large chain, which can be looped through one of the wheels and/or a portion of the frame (interchangeably referred to also as chassis), and often also secured around a suitable stationary object such as a tree or lamp post. The chain must be sufficiently long, making it cumbersome to store and carry.

Other anti-theft arrangements for motorcycles are alarm systems with or without immobilizing systems, GPS assisted tracking systems, etc.

Alternatively, a disk-brake lock may be used. This is a lock, such as that described in U.S. Pat. Nos. 5,265,451 to Phifer and 5,492,206 to Shieh, which is secured through one of the holes formed in the disk portion of a disk-brake, preventing rotation of the motorcycle wheel. This is a highly effective anti-theft device, but has two main disadvantages:

A. It is possible for the motorcycle to attempt traveling a very short distance with the lock in place. This may occur when the owner of the motorcycle forgets that the lock is engaged, or during an attempted of theft by a potential thief or even an un-aware authorized user. The operator then starts the motorcycle, shifts into first gear and starts to roll. The wheel will be able to rotate until the disk-brake lock comes into contact with the brake caliper or some other part of the motorcycle, upon which the wheel will abruptly stop rotating.

This would likely cause the motorcycle to fall over, possibly over the rider, or cause the driver to be thrown from the motorcycle and injured and likely cause damage to various parts of the motorcycle, e.g. damage the disk-brake, necessitating extremely expensive repair work.

Devices intended to warn an operator that a locking device is attached to the motorcycle are known, including U.S. Pat. No. 6,230,530 to Voigt et al. However, in moments of stress or when hurrying, the operator may not notice the warning device or even a warning signal. An ideal lock reminder device would therefore preclude operation of the motorcycle while the lock is engaged. A device aimed at fulfilling this purpose is described by Titterton in U.S. Pat. No. 6,178,787. However, this does not solve the second problem associated with disk-brake locks, as described below.

B. Disk-brake locks are very heavy and bulky and are therefore difficult to transport when the motorcycle is in use, and therefore a suitable storage location is required for this particular style of locks. A disk-brake lock is commonly stored in a pouch or storage bin attached to the chassis of the motorcycle, in the helmet compartment, or similar storage devices, which are extremely inconvenient, or are carried by the operator.

As described in U.S. Pat. No. 4,436,232 to Zane et al., a lock holder has been devised for fastening to the frame of a motorcycle for carrying a motorcycle lock. This comprises a mounting unit for fixing to the frame of a motorcycle and a carrier unit at one side of the mounting unit for carrying a motor lock. However, the lock holder may be heavily vibrated when the motorcycle runs over an uneven road, causing the lock to fall out of the holder. Further lock holders include that described by Lu in U.S. Pat. No. 5,662,255.

U.S. Pat. No. 6,131,427 to Webber et al. describes a footpeg which serves also as a lock holder for a motorcycle, in which the disk lock may be carried by attachment to the footpeg. However, this does not prevent operation of the motorcycle when the lock is engaged and does not provide a significant reminder for the operator to remove the disk-brake lock.

Therefore it is an object of the present invention to provide a motorcycle disk-brake lock which makes it highly unlikely or prevents normal operation of the motorcycle while the lock is engaged to the disk-brake and to thereby provide a clear alert to an operator thereof, and which can be conveniently stored and transported when not in use as a disk-brake lock. Even more so, an attempt to brake the lock may result in irreversible damage thereto such that it may no longer serve functionally, thus prevent operating the motorcycle.

### SUMMARY OF THE INVENTION

Accordingly, it is an object of the present invention to overcome the disadvantages of the prior art and provide a disk-brake lock which when in use as a lock prevents a motorcycle from being operated in the normal manner, and when not in use as a lock may be easily and conveniently carried on the motorcycle.

The present invention, according to its broad aspect, is directed to a disk-brake lock for a motorcycle, which lock is a functional component of the motorcycle, such that it is unlikely to start and roll the motorcycle before disengaging the lock from the disk-brake and reengaging it at another location of the motorcycle for performing its function essential for starting or driving the motorcycle.

The term functional component as used herein the specification and claims denotes any component of the motorcycle required for starting or driving it, such as, for example a footrest peg, a foot-brake paddle, a gear shift peg, a hand-grip, a hand-gas grip etc. Preferably, said functional component is an essential component, i.e. starting or riding the motorcycle is highly unlikely or not possible at all. Typically, a functional component functions and resembles in appearance a conventional corresponding component.

In accordance with an embodiment of the present invention, there is provided a disk-brake lock for a motorcycle comprising a U-like shaped lock member defining a gap sized to receive a wheel disk-brake, a locking unit for removably attaching the lock member to a mounting unit at a functional location of the motorcycle and for locking engagement with the disk-brake. The arrangement is such that the locking unit of said lock member is attachable to said mounting unit for use as a functional component of the motorcycle and, when removed from said mounting unit, may be used as a wheel disk-brake lock.

It is thus possible to provide a motorcycle wherein more than one locking mechanism is provided, e.g. a first element useful as a U-like shaped lock for lockingly embracing the disk-brake (for example the disk-brake of the front wheel), and a second element useful as a locking pin (king-pin type lock) useful for locking engagement with the rear wheel of the motorcycle.

According to a different embodiment, the disk-brake lock is a pin-type lock (at times referred to as a king-pin lock) fitted for locking engagement into a hole of the disk-brake, and attachable to a mounting unit of the motorcycle in the same manner. A lock of this type may be easily fitted on either a front or a rear disk-brake of a motorcycle.

According to one embodiment of the invention, the lock member is functional as a footpeg (also referred to as a footrest) or paddle and according to another embodiment the lock member is functional as a hand grip.

According to still an embodiment of the present invention, the locking unit comprises an integral alarm system which generates an audible alarm signal upon displacement, while engaged with the disk-brake. By a further modification, the locking unit functions as an electronic immobilizer cooperating in conjunction with the mounting unit, such that the motorcycle can not be started without said locking unit. According to one particular application, an alarm/alert system is activated upon an attempt to start the motorcycle when the locking unit is disengaged from the mounting unit.

An advantage of the present invention is that the operator is instantly and automatically reminded that the lock is still engaged when attempting to operate the motorcycle.

A further advantage of the present invention is that a solution is provided for transport and placing of the lock when not in use as a lock.

According to another aspect of the invention, there is provided a motorcycle fitted with a functional component detachably connectable to a mounting unit of the motorcycle for cooperation therewith at an operative position of the motorcycle, and fitted for locking engagement to a disk-brake of the motorcycle to serve as a disk-brake lock; such that it is unlikely to start and roll the motorcycle before disengaging the lock from the disk-brake and re-engaging it to the mounting unit of the motorcycle for performing its function. Additional features and advantages of the invention will become apparent from the following drawings and description.

### BRIEF DESCRIPTION OF THE DRAWINGS

For a better understanding of the invention and to see how it may be carried out in practice, some embodiments will now be described, by way of non-limiting examples only, with reference to the accompanying drawings, in which:

FIG. 1 is a top left isometric view of a motorcycle fitted with a disk-brake lock according to the present invention;

FIG. 2 is an enlargement of the portion marked II in FIG. 1, illustrating the footpeg and gear-shift paddle zone;

FIG. 3A shows the use of a key to remove a multi-purpose disk-brake lock/footpeg from a connector unit on which it is mounted in the footpeg configuration, according to a first embodiment thereof;

FIG. 3B shows the footpeg mounting adapter upon removal of the disk-brake lock/footpeg;

FIG. 3C shows a portion of a disk-brake with the disk-brake lock/footpeg in use as a motorcycle disk-brake lock;

FIG. 4 is an isometric view of the dual-function disk-brake lock/footpeg of FIGS. 3 isolated from the motorcycle;

FIG. 5A is an enlargement of the portion marked V in FIG. 1, illustrating a hand-grip useful also as a disk-brake lock, according to another embodiment of the present invention;

FIG. 5B is an exploded view showing the disk-brake lock/hand-grip and the hand-grip mounting adapter;

FIG. 5C shows a portion of a disk-brake fitted with the disk-brake lock/hand-grip in use as a motorcycle disk-brake lock;

FIG. 6A shows a gear-shift paddle useful also as a disk-brake lock, according to still another embodiment of the present invention;

FIG. 6B shows a portion of a disk-brake fitted with the disk-brake lock/gear-shift paddle in use as a motorcycle disk-brake lock;

FIG. 6C shows the gear-shift paddle mounting adapter upon removal of the disk-brake lock/gear-shift paddle;

FIG. 7A shows a footpeg useful as disk-brake according to a further embodiment of the invention; and

FIG. 7B shows the disk-brake of FIG. 7A lockingly mounted on a disk-brake of a rear wheel of a motorcycle;

FIG. 8A is an isometric view of a foot rest/disk-brake lock according to an embodiment of the invention, detached from a corresponding mounting unit;

FIG. 8B is a schematic sectioned representation illustrating the foot rest/disk-brake lock of FIG. 8A lockingly engaged to the mounting unit; and

FIG. 8C is the same as FIG. 8B, illustrating the foot rest/disk-brake lock detached from the mounting unit.

### DETAILED DESCRIPTION OF THE INVENTION

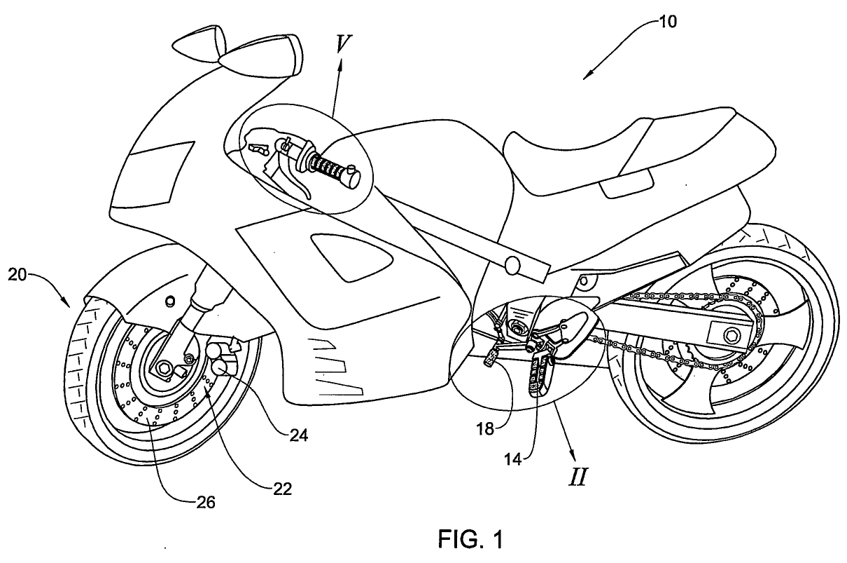

Attention is first directed to FIG. 1 showing a motorcycle generally designated 10 and fitted with a footpeg 14 (also known as a foot rest) on which a motorcycle rider rests his left foot during the operation of the motorcycle and a gear shift paddle 18, operable by the users left foot. Another footpeg is provided at the right side of the motorcycle, serving to rest/support the right foot which typically operates the rear brake pedal (not seen in FIG. 1). The footpeg 14 is a simple device, extending essentially horizontally perpendicular to the body of the motorcycle, which in some instances may be collapsible.

The front wheel assembly 20 of the motorcycle 10 is fitted with a disk-brake assembly 22 comprising a hydraulic caliper system 24 and a braking disk (disk-brake) 26, wherein braking occurs upon squeezing a hand-brake lever (not seen) whilst gripping a hand-grip (also not seen in FIG. 1), resulting in clamping of the calipers about the braking disk 26, as known per se.

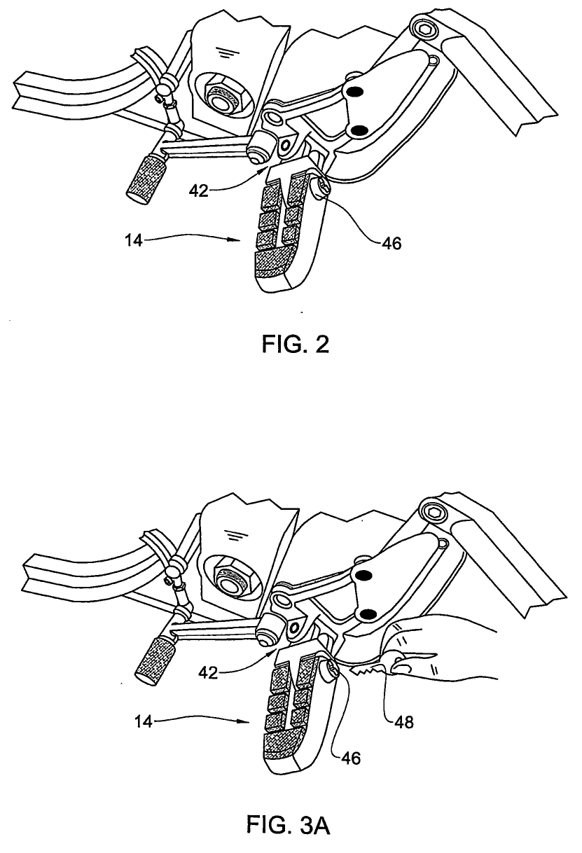

As can better be seen in the enlargement FIGS. 2 to 7, each of the footpeg 14, the paddle portion of gear shift paddle 18 and both hand-grips, comprises a metal core (not clearly seen in some of the Figs.) provided with an outer layer of rubber or similar non-slip material to prevent the operator's foot or hand, respectively, from slipping off the peg or paddle or improving the hand grip, as may be the case. In some cases, a footpeg is provided (not shown) at a bottom outer end with a ground ‘sensor’ which is a downwardly projecting pin useful for indicating to the rider the extent of inclination of the motorcycle, when riding in a curb.

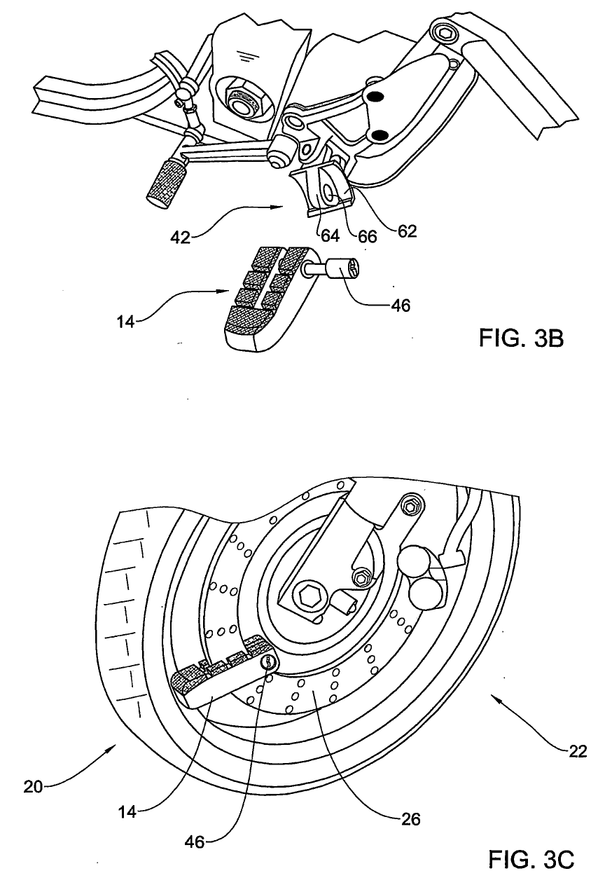

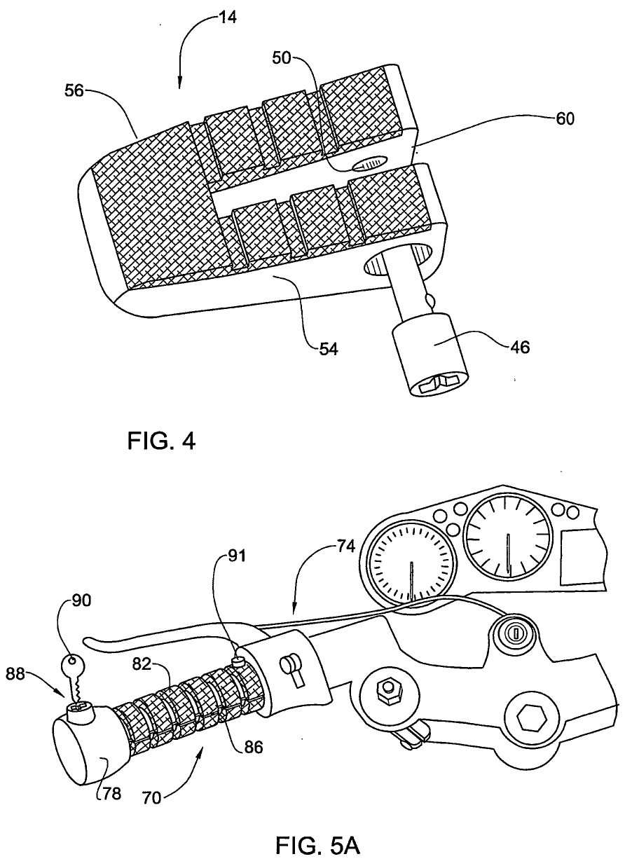

With further reference being made now to FIGS. 2 and 3A to 3C, there is illustrated a first embodiment of a disk-brake lock according to the invention, where the footpeg 14 is removably attached to the motorcycle via a mounting unit 42 (best seen in FIG. 3B) and fastened thereto by pin-lock mechanism 46. A through-hole 50 (seen in FIG. 4) is formed in footpeg 14, such that it may be attached to mounting unit 42 by insertion of the pin-lock mechanism 46 there through. Mounting unit 42 is itself fixedly attached to the motorcycle by a bolt or other standard connecting device or being welded thereto. Pin-lock mechanism 46 is locked and unlocked by appropriate rotation of a key 48 (FIG. 3A) in order for footpeg 14 to be attached to or removed from mounting unit 42. The overall appearance of the footpeg 14 is the same as a conventional footpeg and its functionality is not effected. Preferably, some covering means is provided (not shown) for covering the key-hole of the pin-lock mechanism to thereby protect the locking mechanism from ingress of dirt, mud, water, etc.

It is appreciated that according to an embodiment of the invention, the mounting unit 42 may be attached to the motorcycle also in retrofit, i.e. after the motorcycle has left the factory.

As can be seen in the Figures, and best in FIG. 4, the dual-function disk-brake lock/footpeg 14 comprises a substantially U-like shaped metal body 54 having a rubber anti-slip layer 56 along its upper surface and outer edge. The region between the two parallel sides of the ‘U’ forms a disk receiving slot 60.

In FIG. 2 the disk-brake lock/footpeg 14 is seen in its footpeg configuration functional to support the left foot of the motorcycle rider. In FIG. 3A the pin-lock mechanism 46 is unlocked to enable detachment of the footpeg 14 from the mounting unit 42, as seen in FIG. 3B. This position in itself makes it rather uncomfortable or impossible to ride the motorcycle as the rider will encounter difficulties in shifting gears by means of gear-shift paddle 18.

FIG. 3B shows mounting unit 42 upon removal of disk-brake lock/footpeg 14. Mounting unit 42 comprises a body section 62 fitted with a projecting member 64, formed with a central through-hole 66 for insertion of a locking pin of the pin-lock mechanism 46. At the assembled position of the footpeg 14 over the mounting unit 42, the foot peg is steady and provides firm support. However, according to some embodiments, the footpeg may be foldable about the mounting unit.

Referring now to FIG. 3C, the disk-brake lock/footpeg 14 is shown in use as a disk bake lock. The disk-brake lock/footpeg 14 is mounted on the motorcycle disk-brake 26 such that the disk receiving slot 60 (best seen in FIG. 4) embraces the disk-brake, and then the footpeg/disk-brake lock 14 is locked in place by means of the pin-lock mechanism 46. The motorcycle disk-brake lock/footpeg of the present invention provides a disk-brake lock for use as an anti-theft device, such that the motorcycle cannot be operated with the disk-brake lock engaged, whereby the wheel of the motorcycle is unable to complete a full revolution.

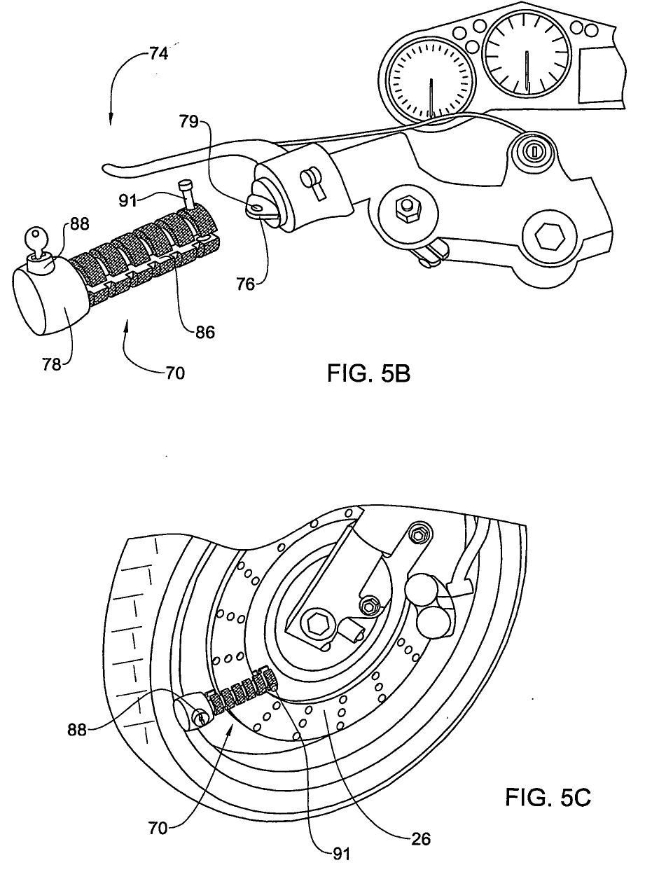

Further attention is now directed to FIGS. 5A to 5C illustrating a further embodiment of a disk-brake lock in accordance with the present invention where a handgrip generally designated 70 (FIG. 5A) is detachably connected to the handlebar assembly 74 by means of a mounting unit 76 (FIG. 5B). The handgrip 70 is a generally round member having a solid metal core 78 and is coated with a suitable rubber 82 for effective and pleasing hand-gripping. The handgrip 70 is formed with a disk-receiving slot 86 sized to accommodate the disk-brake 26.

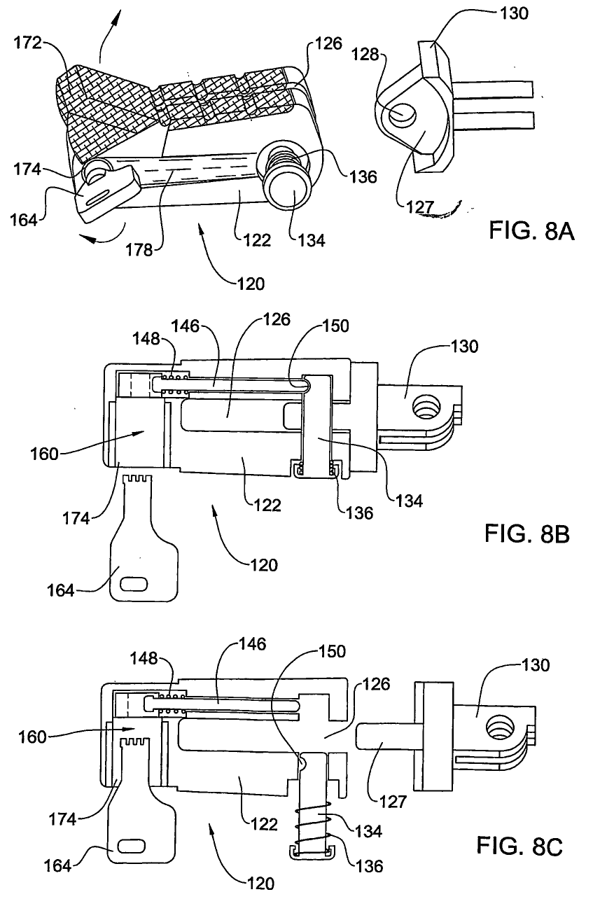

The handgrip 70 is detachable from the mounting unit 76 by a locking mechanism 88 which by means of a key 90 may be locked and firmly attached to the mounting unit 76 by a locking pin 91, or unlocked to remove the handgrip 70 so it can facilitate as a disk-brake lock, in FIG. 5C. When the handgrip 70 is mounted on the disk-brake 26 it is locked in position by same locking mechanism 88 and corresponding locking pin 91. An example of a locking mechanism suitable for that purpose is illustrated with reference to FIGS. 8B and 8C.

In order to prevent rotational displacement of the hand grip 70 with respect to the handlebar assembly 74, the mounting unit 76 is formed with a hole 79 engageable by the corresponding locking pin 91 of the handgrip, so as to ensure correct relative positioning and to prevent said rotational displacement there between.

According to a particular embodiment, the hand grip is an assembly wherein the span of the disk-receiving slot is variable between a constricted position when attached to the mounting unit, and an expanded position for locking engagement with a disk-brake. Accordingly, while attached to the mounting unit 76, the slot 86 is constricted where it is practically not noticeable (FIG. 5A), and when it is detached from the mounting unit 76 the slot 86 spontaneously expands (FIGS. 5B and 5C) to a size suited for accommodation of the disk-brake. This arrangement is facilitated by means of the locking mechanism 88 and a loaded spring (not shown).

The arrangement is such that when the handgrip 70 is in use as a disk-brake lock (FIG. 5C) it is absent from the handlebar assembly 74 (FIG. 5B) and therefore, when an operator wishes to prepare for driving the motorcycle, he will immediately notice that the handgrip is missing and will thus become aware that the disk-brake lock is still engaged. Further, the operator will not be able to shift the motorcycle into gear and it is thus unlikely that the machine can be driven.

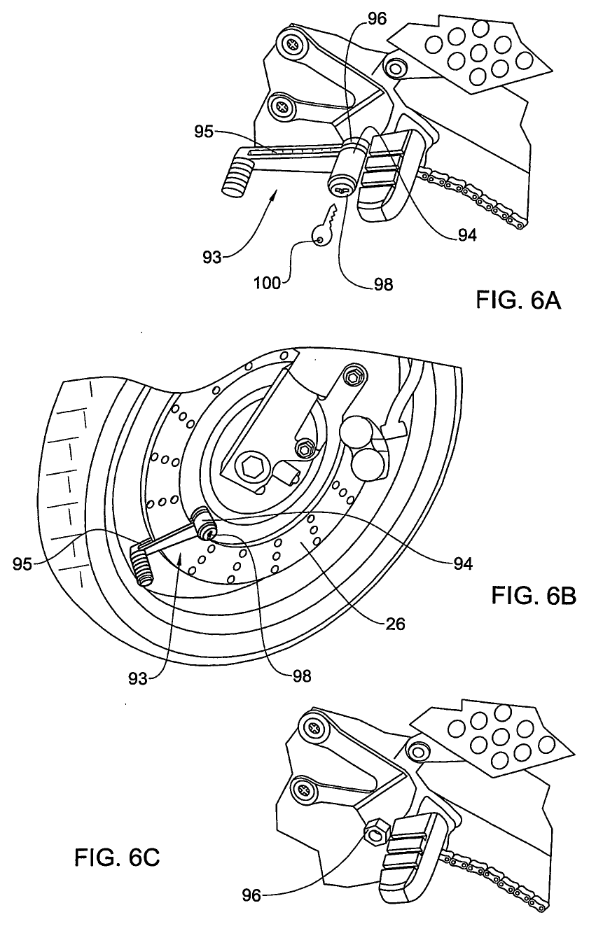

Turning now to FIGS. 6A-6C, there is illustrated still a different embodiment wherein a gear-shift pedal 93 is dual-function and serves as a gear-shift pedal (FIG. 6A) and as a disk-brake lock (FIG. 6B). The gear-shift pedal 93 comprises a disk-brake receiving slot 95 and a connecting portion 94 (FIG. 6A) for lockingly mounting over a connecting/mounting unit 96 (FIG. 6C) by means of a locking mechanism 98 and an appropriate key 100. Connecting/mounting unit 96 has a hexagonal cross-section (FIG. 6C) snugly receivable within a corresponding receptacle formed at the gear-shift pedal 93 (not seen) to thereby fix the relative angular position there between.

In its function as a gear-shift pedal 93 (FIG. 6A) the device is tightly secured to the mounting unit 96 to avoid relative displacement between the gear-shift pedal 93 and the mounting unit 96 whereby gear shifting by said pedal is not effected.

In its function as a disk-brake lock, the gear-shift pedal 93 is secured over the disk-brake 26 and is locked in place by means of the locking mechanism 98, as in FIG. 6B. A protective cap or cover may be fitted over the locking mechanism 98, for the reasons mentioned hereinabove.

It is appreciated that in its function as a disk-brake lock, the gear-shift pedal 93 is absent from its originally intended position as a gear-shift pedal (FIG. 6A) whereupon the motorcycle cannot be operated and whereby the motorcycle rider will become aware of the fact that the disk-brake lock is engaged with the disk-brake instantaneously upon sitting on the motorcycle.

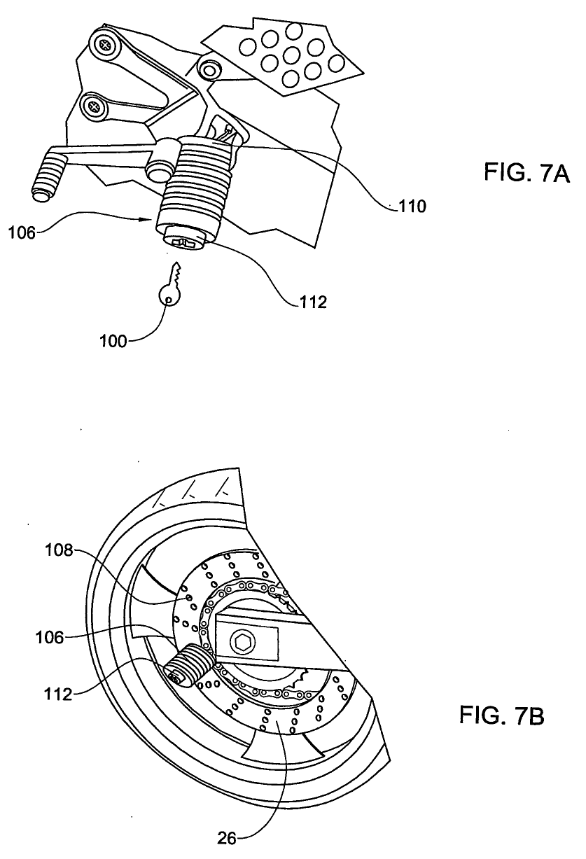

The embodiment of FIGS. 7A and 7B illustrates still a modification of the invention wherein a footpeg (also referred to as a foot rest) 106 is a dual-function device serving as a footpeg in FIG. 7A to facilitate gear shifting, and serving as a king-pin type disk-brake lock (FIG. 7B), for lockingly engaging within one of the plurality of holes 108 formed in a conventional disk-brake 26 (on either a front or rear disk-brake of the motorcycle).

The footpeg 106 is lockingly mounted to a corresponding mounting unit 110 and is lockingly attached or detached therefrom by means of the locking mechanism 112 of the king-pin. By the same king-pin and locking mechanism the footpeg 100 is lockingly engaged to the disk-brake (a rear wheel of the motorcycle in the present example), as in FIG. 7B. According to some other embodiments (not shown) rather or in addition to using the footpeg 106, one could also use the gear-shift paddle, a hand-grip, etc.

Similar to the arrangement of the previous embodiments, also in the embodiment depicted in FIGS. 7A and 7B, the disk-brake lock/footpeg serves as an anti-theft device such that the motorcycle cannot be operated with the disk-brake lock engaged on the one hand, whilst, on the other hand, an attempt to operate the motorcycle with the disk-brake lock 106 engaged, will immediately alert the operator who will become aware that the disk-brake lock is still engaged.

Further attention is now directed to FIGS. 8A-8C of the drawings illustrating a particular embodiment of a footrest-disk-brake lock in accordance with a modification of the present invention. The footrest generally designated 120 has an overall shape similar to footpeg 14 as illustrated in FIG. 4, and comprises a body portion 122 formed with a disk-receiving slot 126 sized and shaped for alternate locking engagement with a connector 127 of a mounting unit 130 (similar to mounting unit 62 in FIG. 3B) and for locking engagement in an embracing manner over a disk-brake as explained in connection with the embodiments of FIGS. 2 to 4.

The footpeg 120 further comprises a locking pin 134 spring biased by a coil-spring 136 into its retracted position as in FIGS. 8A and 8C, though prevented from removal e.g. by a restricting pin (not seen), so as to prevent losing the pin 134 and the associated spring 136. Pin 134 serves for locking engagement of the footpeg 120 by penetration into hole 128 (FIG. 5A) of mounting unit 130 and for locking embracement over a brake-disk.

Locking pin 134 is controlled by an axially displaceable locking rod 146, fitted for arresting the locking pin 134 by engagement with a corresponding notch 150 formed at an end of the locking pin 134 (FIGS. 8B and 8C). By means of a coiled spring 148 is biased to retract from the notch 150. Locking rod 146 is manipulable by means of a locking mechanism 160 which by a removable key 164 propels the locking pin 146 into locking engagement with notch 150 Of the locking pin 134 (FIG. 8B), to facilitate its locking engagement with a mounting unit 130 or embracingly over a disk-brake (not shown). Unlocking the lock mechanism 160 permits the locking rod 146 to spontaneously retract into its open position (FIG. 8C) to disengage from notch 150 of the locking pin 134 to thereby facilitate disengagement from the mounting unit 130 or from a brake-disk, respectively.

As can further be noted in FIG. 8A, the footpeg 120 is formed with a pivotable cover unit 172 fitted for covering the keyhole 174 of the locking mechanism 160, to thereby prevent dirt, e.g. mud, water, etc. from entering the locking mechanism.

Furthermore, the footpeg 120 is formed with a gliding grove 178, which facilitates easy location of the keyhole 174 by mealy sliding the key 164 over the grove 178, directing the key 164 into the keyhole 174. This arrangement is useful for fast insertion of the key into the keyhole also at extreme conditions e.g. at poor visibility, wearing gloves, etc. Still, the arrangement is such that sliding the key 164 over the gliding grove 178, entails displacement of the cover unit 172 into its open positing.

It is apparent that a motorcycle may be fitted with two or more locking arrangements according to the invention where, for example, one lock is fitted for locking engagement with the front disk-brake (either by embracing or as a king-pin type lock) and an other lock is fitted for locking engagement with the rear disk-brake (typically as a king-pin type lock). It is thus possible to increase the security level by providing more than one locking mechanism and by simultaneous removal more than one essential component from the motorcycle.

In addition to solving the problem of a motorcycle operator inadvertently attempting to ride the motorcycle with a disk-brake lock engaged, the device of the present invention also solves the problem of storing and transporting the lock when not in use, since the lock is transported in the form of a footpeg.

The disk-brake lock/footpeg of the present invention therefore provides an effective method for efficiently and conveniently transporting a disk-brake lock, while also preventing damage to the motorcycle and the operator by neglecting to remove the disk-brake lock before commencing operation of the motorcycle.

According to other modifications of the invention the mounting unit comprises a discreet connector for connecting only to a designated mating coupler of the component. Such a discreet connection may be obtained, for example, by forming the mounting unit in the form of a pin having a polygonal cross section or an abnormal cross section, where the mating portion of the locking mechanism of the lock component has a receptacle formed with a corresponding cross section.

By a further embodiment, the locking member may constitute part of an electronic immobilizing system, such that, for example, the ignition system of the motorcycle will not ignite at the absence of the locking component (e.g. footpeg or hand-grip) from its functional location attached to the motorcycle. Evermore so, the arrangement may be such that an attempt to ignite the motorcycle before attaching the locking member to its functional location, may trigger an alarm signal such as an audible signal, etc.

Whilst several embodiments have been shown and described, it is to be understood that it is not intended thereby to limit the disclosure, but rather it is intended to cover all embodiments, modifications and arrangements falling within the spirit and the scope of the present invention, as defined in the appended claims, mutatis mutandis.

1. A lock for a motorcycle, which lock is a functional component for operating the motorcycle; said component comprising a locking mechanism for detachable locking to a mounting unit of the motorcycle for performing its function, and for locking engagement to a disk-brake of the motorcycle.

2. A lock according to claim 1, wherein the component is functional as a footpeg of the motorcycle.

3. A lock according to claim 1, wherein the component is functional as a hand-grip of the motorcycle.

4. A lock according to claim 1, wherein the component is functional as a gear-shift paddle of the motorcycle.

5. A lock according to claim 1, wherein the component comprises a U-like shaped portion with a disk-receiving slot formed between arms of the component for embracing a portion of the disk-brake of the motorcycle.

6. A lock according to claim 5, wherein the disk-receiving slot extends between two parallel walls of the arms.

7. A lock according to claim 1, wherein the component comprises a rigid metal core formed or coated with an anti-slip surface.

8. A lock according to claim 1, wherein the locking mechanism is a pin-type lock adapted for locking engagement with the mounting unit and for locking engagement with an aperture formed in the disk-brake.

9. A lock according to claim 8, wherein the functional component serves as one of a hand-grip, a footpeg and a gear paddle.

10. A lock according to claim 1, wherein a gear shifting mechanism of the motorcycle comprises a footpeg and a gear paddle, both of which being detachable functional components suited for locking engagement with a disk-brake of the motorcycle.

11. A lock according to claim 1, wherein the component accommodates an alarm system for generating an audible alarm signal upon attempting to move the motorcycle when the component is lockingly engaged with the disk-brake.

12. A lock according to claim 1, wherein the component comprises an electronic immobilizer cooperating in conjunction with the mounting unit, to thereby dysfunction an ignition system of the motorcycle whenever the component is detached from the mounting unit.

13. A lock according to claim 11, wherein an attempt to ignite the motorcycle prior to attaching the component to the mating mounting unit, generates an alarm signal.

14. A lock according to claim 1, wherein the mounting unit comprises a discreet connector for connecting only to a designated mating coupler of the component.

15. A disk-brake lock for a motorcycle, which lock is a functional component of the motorcycle, such that it is unlikely to start and roll the motorcycle before disengaging the lock from the disk-brake and reengaging it at another location of the motorcycle for performing its function essential for starting or driving the motorcycle.

16. A lock according to claim 1, wherein the functional component may be retro-fitted to the motorcycle.

17. A lock according to claim 1, wherein the mounting unit may be retro-fitted to the motorcycle.

18. A lock according to claim 1, wherein a key-hole of the locking mechanism is fitted with a cover.

19. A lock according to claim 1, wherein a key-hole of the locking mechanism extends within a guide-track to facilitate guiding a key into said key-hole.

20. A lock according to claim 1, wherein the locking mechanism comprises a retractable locking pin which while serving as a functional component functions as a coupling hinge.

21. A lock according to claim 1, wherein the component is a footrest fitted at a bottom face thereof with a ground-engaging probe.

22. A mounting unit for a motorcycle lock being fixedly attachable to a frame of the motorcycle and comprises a connecting portion for lockingly attaching thereto a locking mechanism of a functional component of the motorcycle, and where said locking mechanism serves also for locking engagement of the lock to a disk-brake of the motorcycle.

23. A motorcycle fitted with a lock, which lock is a functional component for operating the motorcycle; said component comprising a locking mechanism for detachable locking to a mounting unit of the motorcycle for performing its function, and for locking engagement to a disk-brake of the motorcycle.
